(19) United States
(12) Patent Application Publication
(10) Pub. No.: US 2012/0291050 A1
(43) Pub. Date: Nov. 15, 2012

(54) PROCESSING SYSTEM AND METHOD OF EVENT GENERATION

(76) Inventors: Po-Yuan YEH, Taipei (TW); Lan-Chih Yang, Taipei (TW)

(21) Appl. No.: 13/464,438

(22) Filed: May 4, 2012

Related U.S. Application Data
(60) Provisional application No. 61/485,467, filed on May 12, 2011.

(51) Int. Cl. G06F 9/46; G06F 3/00

(52) U.S. Cl. 719/318

(57) ABSTRACT

A processing method of event generation is suitable for execution with an electronic device. The processing method includes the following steps of: generating an event by a generating module, selecting a processing path from a routing table corresponding to the event, and controlling the generating module by a control unit to transmit the event to at least one module according to the selected processing path.

### CROSS REFERENCE TO RELATED APPLICATIONS

The non-provisional patent application claims priority to U.S. provisional patent application with Ser. No. 61/485,467 filed on May 12, 2011. This and all other extrinsic materials discussed herein are incorporated by reference in their entirety.

### BACKGROUND OF THE INVENTION

1. Field of Invention

The present disclosure relates to a processing method and system, and in particular, to a processing method and system of event generation.

2. Related Art

As the development of information technology and the continuous progress of life standard, the demands for fast and convenience are increased gradually. Regarding to the computer system, the researchers usually analyzes the operation system of the computer system for decreasing the resource consumption, thereby improving the performance of the computer system.

When the user operates the electronic device or changes the status of the electronic device by, for example, clicking the mouse, recording, zooming in/out a picture, operating a window, or controlling the sound, the operation system generates a corresponding event and then enables a module that can process or execute the desired function for processing the generated event.

In the conventional art, the event can be processed by two ways. The first way is to encode the processing methods corresponding to the event in the program code by API Library. For example, when an event of zooming in a picture occurs, a preset corresponding module is enabled to process the event of zooming in a picture. However, this method can not enable multiple modules to process a single event. Thus, when the event needs to be transmitted to different modules for encoding, multiple times of processing periods are spent to process the same procedure repeatedly. In addition, once the software or hardware is renewed or updated, the program code must be compiled again for normally executing the new system. This process may waste a lot of time and labor hours, and further need a lot of performance of the operation system.

The second way is to sequentially transmit the event to multiple modules until finishing a loop. This way is also called a plug-in method. However, among these modules, only several modules can perform the process action of the event. In other words, when a module is not to process the event, it transmits the event to the next module. Besides, when one of the modules has finished the process action with respect to the event, it still transmits the event to the next one until all modules have received the event instead of feeding back the finished event. This method for processing the event need too much time in the transmission and waiting of the event, thereby decreasing the system performance.

### SUMMARY OF THE INVENTION

A processing method of event generation of the present disclosure is suitable for execution with an electronic device. The processing method includes the following steps of: generating an event by a generating module, selecting a processing path from a routing table corresponding to the event, and controlling the generating module by a control unit to transmit the event to at least one module according to the selected processing path.

The processing method of event generation of the present disclosure is suitable for a software system, an operation system, a central processing unit (CPU) or hardware of the electronic device.

In one embodiment, the routing table comprises a plurality of processing paths.

In one embodiment, the event corresponds to one or more processing paths.

In one embodiment, the control unit outputs a control signal to control the generating module to transmit the event.

In one embodiment, when the generating module transmits the event to at least one module, the event is transmitted to multiple modules simultaneously.

A processing system of event generation of the disclosure is suitable for an electronic device and comprises a generating module, a storage unit and a control unit. The generating module generates an event. The storage unit comprises a routing table, and at least one processing path is selected from the routing table corresponding to the event. The control unit controls the generating module to transmit the event to at least one module according to the selected processing path.

In one embodiment, the processing system is suitable for a software system, an operation system, a central processing unit (CPU) or hardware of the electronic device.

In one embodiment, the routing table comprises a plurality of processing paths.

In one embodiment, the event corresponds to one or more processing paths.

In one embodiment, the control unit outputs a control signal to control the generating module.

In one embodiment, the generating module transmits the event to multiple modules simultaneously.

As mentioned above, the processing system and method of event generation of this disclosure are applied to an electronic device. After an event is generated, at least one processing path is selected from a routing table corresponding to the event, and the control unit controls the generating module to transmit the event to at least one module according to the selected processing path, thereby performing the process of this event. In brief, the control unit controls the generating module to directly transmit the event to the specific module capable of processing this event. Besides, the generating module may transmit the event to multiple modules, so that these modules can simultaneously process this event. These features can increase the efficiency of processing event, decrease the processing time, and reduce the resource consumption of the operation system.

These and other features, aspects and advantages of the present invention will become better understood with regard to the following description, appended claims, and accompanying drawings.

### BRIEF DESCRIPTION OF THE DRAWINGS

FIG. 1 is a flow chart showing the steps of a processing method of event generation according to an embodiment of the disclosure;

FIG. 2 is a schematic diagram showing a processing system of event generation according to the embodiment of the disclosure;

FIG. 3 is a schematic diagram showing a processing path of the disclosure;

FIG. 4 is a schematic diagram showing another processing path of the disclosure;

FIG. 5 is a schematic diagram showing another processing path of the disclosure;

FIG. 6 is a schematic diagram showing another processing path of the disclosure; and

FIG. 7 is a schematic diagram showing the processing flow according the processing method of the disclosure.

### DETAILED DESCRIPTION OF THE INVENTION

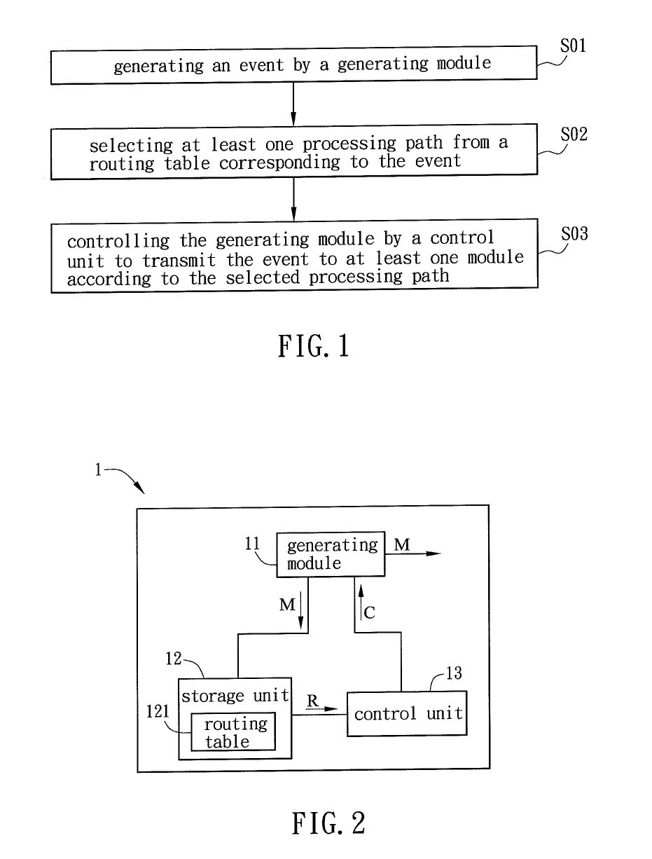

FIG. 1 is a flow chart showing the steps of a processing method of event generation according to an embodiment of the disclosure. The processing method of event generation of this embodiment is suitable for execution with an electronic device such as a software system, an operation system, a central processing unit (CPU) or hardware of the electronic device. The processing method comprises the following steps S01 to S03.

FIG. 2 is a schematic diagram showing a processing system 1 of event generation according to the embodiment of the disclosure. With reference to FIGS. 1 and 2, in the step S01, a generating module 11 generates an event M. In this step S01, the user can operate the electronic device to change the status of the electronic device so as to enable the generating module 11 to generate the event M. Herein, the event may include, for example but not limited to, clicking a mouse, recording, selecting a functional key, zooming in/out a picture, closing a window, controlling the sound, or the likes.

The step S02 is to select a processing path from a routing table 121 corresponding to the event M. The routing table 121 comprises a plurality of processing paths corresponding to different events. To be noted, one event may correspond to one processing path or multiple processing paths. In practice, it is to determine and select the processing path(s) corresponding to the event based on the situation of the event generation. In this embodiment, the routing table 121 is, for example but not limited to, a configuration file. Besides, the routing table 121 is stored in a storage unit 11.

In the step S03, a control unit 13 controls the generating module 11 to transmit the event M to at least one module according to the selected processing path R.

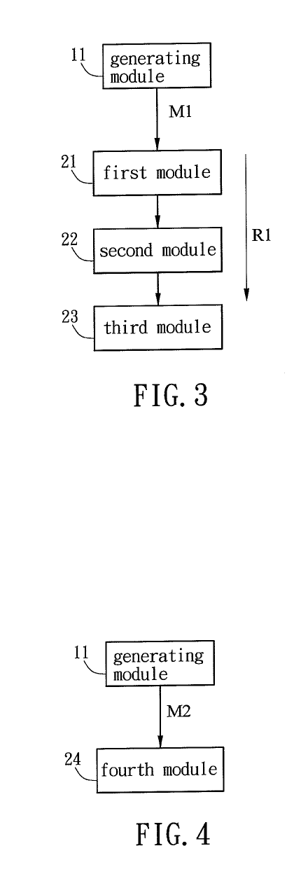

FIG. 3 is a schematic diagram showing a processing path of the disclosure. Referring to FIGS. 1, 2 and 3, when a first event M1 is generated, a processing path corresponding to the first event M1 is selected from the routing table 121, and the control unit 13 outputs a control signal C to the generating module 11 according to the selected processing path corresponding to the first event M1. Then, the generating module 11 is controlled to sequentially transmit the first event M1 to a first module 21, a second module 22 and a third module 23 for executing the relative operation and process of the first event M1. In this case, the path indicating that the first event M1 is sequentially transmitted to the first module 21, the second module 22 and the third module 23 represents the processing path R1 corresponding to the first event M1.

To be noted, the first module 21, the second module 22 and the third module 23 may have different functions, so that different processes with respect to the first event M1, as the first event is sequentially transmitted to the first module 21, the second module 22 and the third module 23, are performed.

FIG. 4 is a schematic diagram showing another processing path of the disclosure. Referring to FIGS. 2 and 4, if the user intends to zoom in a window and presses a function key for zooming in the window, the generating module 11 generates an event M2 of zooming in a window. Then, the processing path corresponding to the event M2 is selected from the routing table. For example, assuming a fourth module 24 is able to perform the operation of zooming in a window, the routing table 121 should include a processing path R that indicates the event M2 to be transmitted to the fourth module 24 as the event M2 of zooming in a window is generated. According to the selected processing path R, the control unit 13 controls the generating module 11 to transmit the event M2 to the fourth module 24, and the fourth module 24 can continuously perform the operation of zooming in a window.

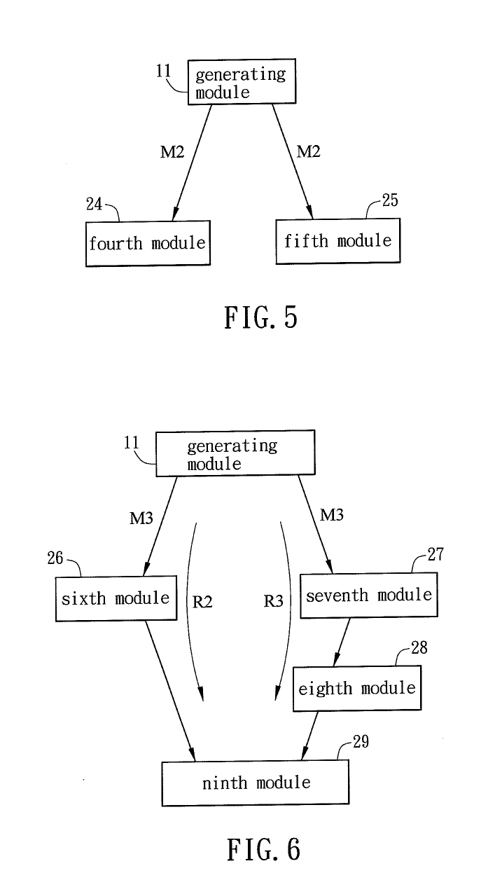

To be noted, the processing paths of the routing table can be modified or updated according to the number and functions of the available modules or by updating the configuration file and modules. FIG. 5 is a schematic diagram showing another processing path of the disclosure. Referring to FIGS. 2 and 5, assuming a fifth module 25 is also able to perform the operation of zooming in a window, the control unit 13 as well as the routing table 121 can determine that, as the event M2 of zooming in a window is generated, the event M2 can be transmitted to the fourth module 24 or the fifth module 25 for performing the operation of zooming in a window. Although the fourth module 24 and the fifth module 25 are all able to perform the operation of zooming in a window, their performances or speeds are different. For example, the fourth module 24 is to zoom in the window and to enlarge the font size of the contents in the window, while the fifth module 25 is to zoom in the window and to maintain the font size of the contents in the window (the word numbers in each column are increased).

Alternatively, it is also possible to transmit one event to multiple modules, so that a plurality of processing paths are selected for processing the event, thereby enhancing the processing performance and shortening the processing time. FIG. 6 is a schematic diagram showing another processing path of the disclosure. With reference to FIGS. 1, 2 and 6, if a third event M3 is generated, a processing path corresponding to the third event M3 is selected from the routing table 121. According to the selected processing paths, the third event M3 is transmitted to a sixth module 26 and a seventh module 27, and then from the seventh module 27 to an eighth module 28. Afterward, a ninth module 29 can integrate and process the events from the sixth module 26 and the eighth module 28. Herein, the path of sequentially transmitting the third event M3 to the sixth module 26 and the ninth module 29 is a processing path R2 of the third event M3, and the other path of sequentially transmitting the third event M3 to the seventh module 27, the eighth module 28 and the ninth module 29 is another processing path R3 of the third event M3. The third event M3 is processed according to both of the processing paths R2 and R3, and the processing results are integrated in the ninth module 29. If the ninth module 29 has processed the third event M3, the processing result is outputted; otherwise, if the ninth module 29 does not process the third event M3 yet, the third event M3 is transmitted to the next module according to the processing paths for continuously performing and processing the third event M3.

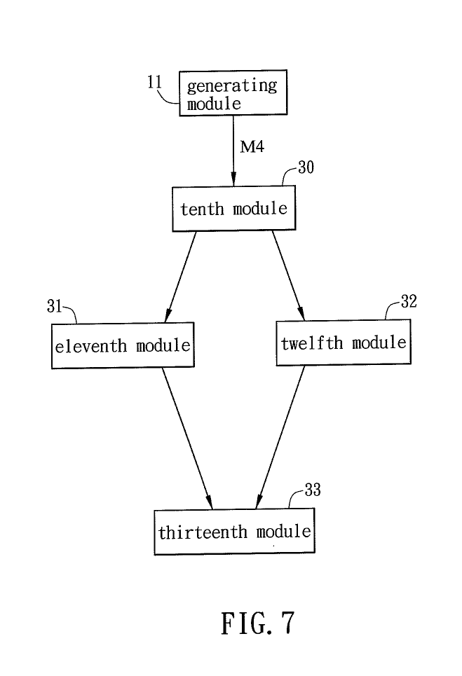

FIG. 7 is a schematic diagram showing the processing flow according the processing method of the disclosure. With reference to FIGS. 1, 2 and 7, if the user operates the electronic device for executing a recording function, the step S01 is firstly performed to generate a recording event M4 by the generating module 11.

The generating module 11 then transmits the recording event M4 to the storage unit 12, and in the step S02, at least one processing path R corresponding to the event M4 is selected from the routing table 121, and the selected processing path R is transmitted to the control unit 13. Next, in the step S03, the control unit 13 controls the generating module 11 to transmit the event M4 to at least one module according to the processing path R.

The processing method and flow of the recording event M4 will be further described hereinafter. After the recording event M4, the control unit 13 transmits the event M4 to a tenth module 30 according to the processing path R corresponding to the event M4. In this embodiment, the tenth module 30 is, for example, a feature extraction encoding module, which can perform the transform coding of the record data according to the recording event M4, for the following processes.

After the coding procedure of the tenth module 30, the data are transmitted to an eleventh module 31 and a twelfth module 32. In this embodiment, the eleventh module 31 is a decoding module for decoding the encoded data and outputting a string, while the twelfth module 32 is a user identification module for receiving the encoded data and searching and outputting the corresponding user data. Finally, the eleventh module 31 transmits the string data to a thirteenth module 33, and the twelfth module 32 also transmits the user data to the thirteenth module 33. Consequently, the thirteenth module 33 can integrate and process the received data from the eleventh module 31 and the twelfth module 32. In this embodiment, the thirteenth module 33 can further output the integrated data, which are displayed on the screen of the electronic device.

In addition, a processing system 1 of event generation of the disclosure is suitable for a software system, an operation system, a central processing unit (CPU) or hardware of an electronic device. The processing system 1 comprises a generating module 11, a storage unit 12 and a control unit 13. The generating module 11 generates an event M according to the user operating the status of the electronic device. The storage unit 12 comprises a routing table 121, and at least one processing path R is selected from the routing table 121 corresponding to the event M. The control unit 13 controls the generating module 11 to transmit the event M to at least one module according to the selected processing path R. Herein, the features of the generating module 11, storage unit 12, control unit 13, event M, processing path R and module are the same as those of the generating module 11, storage unit 12, control unit 13, events M, M1-M4, processing paths R, R1-R3, and modules 21-33, so the detailed descriptions thereof will be omitted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A processing method of event generation suitable for execution with an electronic device, the processing method comprising the following steps of:
generating an event by a generating module;
selecting at least one processing path from a routing table corresponding to the event; and
controlling the generating module by a control unit to transmit the event to at least one module according to the selected processing path.

2. The processing method of claim 1, wherein the processing method is suitable for a software system, an operation system, a central processing unit (CPU) or a hardware of the electronic device.

3. The processing method of claim 1, wherein the routing table comprises a plurality of processing paths.

4. The processing method of claim 1, wherein the event corresponds to one or more processing paths.

5. The processing method of claim 1, wherein the control unit outputs a control signal to control the generating module to transmit the event.

6. The processing method of claim 1, wherein when the generating module transmits the event to at least one module, the event is transmitted to multiple modules simultaneously.

7. A processing system of event generation suitable for an electronic device, the processing system comprising:
a generating module generating an event;
a storage unit comprising a routing table, wherein at least one processing path is selected from the routing table corresponding to the event; and
a control unit controlling the generating module to transmit the event to at least one module according to the selected processing path.

8. The processing system of claim 7, wherein the processing system is suitable for a software system, an operation system, a central processing unit (CPU) or a hardware of the electronic device.

9. The processing system of claim 7, wherein the routing table comprises a plurality of processing paths.

10. The processing system of claim 7, wherein the event corresponds to one or more processing paths.

11. The processing system of claim 7, wherein the control unit outputs a control signal to control the generating module.

12. The processing system of claim 7, wherein the generating module transmits the event to multiple modules simultaneously.
